(19) United States
(12) Patent Application Publication
(10) Pub. No.: US 2017/0355084 A1
(43) Pub. Date: Dec. 14, 2017

(54) ROBOT HAND APPARATUS AND ROBOT ARM FOR SAME

(71) Applicant: HON HAI PRECISION INDUSTRY CO., LTD., New Taipei (TW)

(72) Inventors: CHIA-SHOU CHANG, New Taipei (TW); TSU-LI CHIANG, New Taipei (TW); FONG-HAN LIN, New Taipei (TW); CHENG-WEI LAI, New Taipei (TW)

(21) Appl. No.: 15/620,830

(22) Filed: Jun. 13, 2017

Related U.S. Application Data
(60) Provisional application No. 62/349,629, filed on Jun. 13, 2016.

(51) Int. Cl. B25J 15/12; B25J 15/10

(52) U.S. Cl. CPC B25J 15/12; B25J 15/10; Y10S 901/39

(57) ABSTRACT

A robot hand apparatus includes a base, three finger mechanisms, a thumb mechanism, and three motors for the three finger mechanisms. The base corresponds to a part of the hand of a human, i.e. a palm and dorsum of a human. Each of three finger mechanisms is elongated in almost the same direction from the end of the base and is adapted to be actuated by the motor. The thumb mechanism is elongated from the different portion from the base. The thumb mechanism and the finger mechanism close to the thumb mechanism are configured to define a U-shape space.

### FIELD

The subject matter herein generally relates to a robot hand apparatus and a robot arm for use therewith.

### BACKGROUND

Recently, robots have been given an external appearance similar to a human and the ability to perform like a human. However, the functionality of robotic hand devices can be improved upon.

### BRIEF DESCRIPTION OF THE DRAWINGS

Implementations of the present technology will now be described, by way of example only, with reference to the attached figures.

FIG. 1 is an isometric view of a robot hand apparatus.

FIG. 2 is an exploded view of the robot hand apparatus of FIG. 1.

FIG. 3 is a cutaway view of fingers of the robot hand apparatus of FIG. 1.

FIG. 4 is an isometric view of a robot arm.

FIG. 5 is an exploded view of the robot hand apparatus of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

Definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a robot hand apparatus and a robot arm for the robot hand apparatus.

A humanoid robot is provided with robot hands having shapes corresponding to human hands so that the robot can do the work normally performed by a human. The robot hand substantially includes a base member corresponding to the palm of the hand and the dorsum the hand, and finger mechanisms corresponding to human fingers. The finger mechanisms are rotatably coupled to the base member to enable the grasping of various objects while rotating. Each of the fingers has joint members so that the fingers can be rotated by different parts.

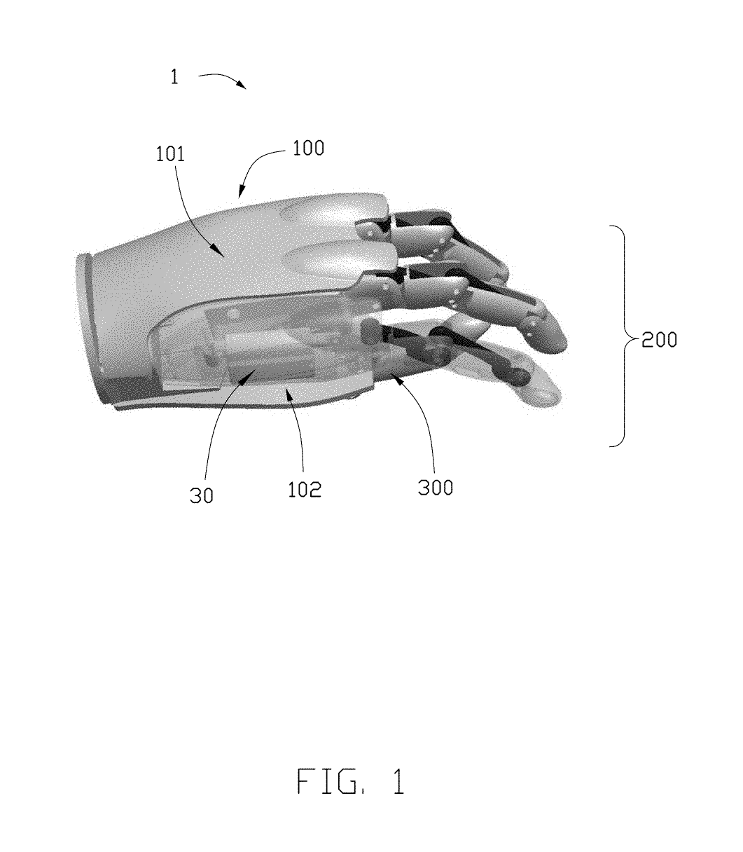

FIG. 1 illustrates a robot hand apparatus 1 comprises a base 100, at least three finger mechanisms 200, a thumb mechanism 300, and three motors 30 for the three finger mechanisms 200. The base 100 corresponds to a part of the hand of a human, i.e. a palm and dorsum of a human. Each of three finger mechanisms 200 is elongated in almost the same direction from the end of the base 100 and is adapted to be actuated by the motor 30. The thumb mechanism 300 is elongated from a different portion of the base 100. The thumb mechanism 300 and the finger mechanism 200 closed to the thumb mechanism 300 are configured to define a U-shape space.

In one exemplary embodiment, only one of the three finger mechanisms 200 as a first finger (the shortest finger) is described, and the explanation about other finger mechanisms 200 will be omitted. The other finger mechanisms 200 are only different in size from the first finger mechanism 200. Thus, the descriptions herein can be applied to robotic hands having varying numbers of fingers.

The thumb mechanism 300 is adapted to be actuated by another motor (not shown) other than the motor 30. In this exemplary embodiment, the power from the motor 30 is not transferred to the thumb mechanism 300, i.e. the thumb mechanism 300 does not correspond to the finger mechanism 200. It is not limited to the example of this exemplary embodiment; the thumb mechanism 300 may be actuated together with other finger mechanisms using the same power source for the actuation of the finger mechanism.

The base 100 comprises a palm section 102 with a curved shape and a dorsum section 101. In this exemplary embodiment, the motor 30 and partial portions of the three finger mechanisms 200 are stored in the space formed by combining the palm section 102 with the dorsum section 101.

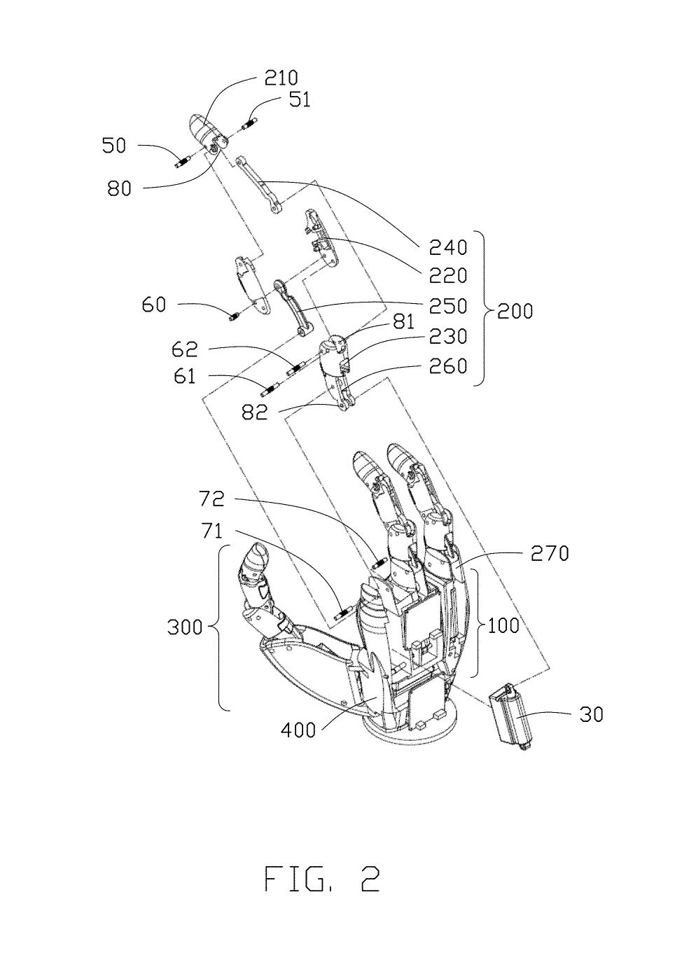

The finger mechanism 200, as shown in FIG. 2, comprises a fingertip member 210, an intermediate member 220, a base member 230, a first linkage 240, a second linkage 250, a link arm 260 and a link base 270.

The fingertip member 210 and the base member 230 are connected through a first linkage 240. One end of the first linkage 240 is rotatably connected to the fingertip member 210 by first joint member 80 through a first fingertip bolt 50. The other end of the first linkage 240 is rotatably connected to base member 230 by second joint member 81 through a second intermediate bolt 61.

The intermediate member 220 and the link base 270 are connected through a second linkage 250. One end of the second linkage 250 is rotatably connected to the intermediate member 210 by third joint member 82 through a first intermediate bolt 60. The other end of the second linkage 250 is rotatably connected to the base member 230 by third joint member 82 through a second intermediate bolt 72.

The fingertip member 210 and the intermediate member 220 are connected by first joint member 80 through a second fingertip bolt 51.

The intermediate member 220 and the base member 220 are connected by second joint member 81 through a base member bolt 62.

The base member 230 includes a link arm 260. One end of the link arm 260 is rotatably connected with the link base 270 by third joint member 82 through a first base bolt 71. The link arm 260 is also coupled to the motor 30 so that the motor 30 is configured to control the finger mechanism 200.

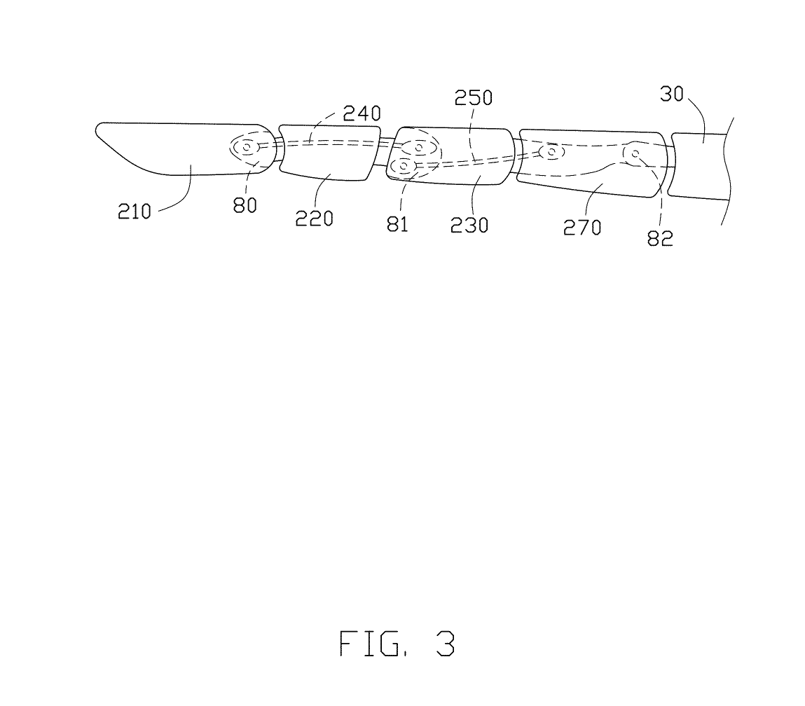

FIG. 3 illustrates a finger structure that the fingertip member 210 and the base member 230 are connected through a first linkage 240. One end of the first linkage 240 is rotatably connected to the fingertip member 210 by the first joint member 80. The other end of the first linkage 240 is rotatably connected to base member 230 by the second joint member 81.

The intermediate member 220 and the link base 270 are connected through a second linkage 250. One end of the second linkage 250 is rotatably connected to the intermediate member 220 by the third joint member 81. The other end of the second linkage 250 is rotatably connected to the link base 270.

When the motor 30 is activated, the link arm 260 connected with the motor 30 can be rotated by the third joint member 82. The end of the second linkage 250 near the link base 270 is simultaneously rotated because the link arm 260 is rotated by the third joint member 82. When the second linkage 250 is rotated, the end of the second linkage away from the link base 270 is rotated by the second joint 81. The end of the first linkage 240 near the link base 270 and the end of the second linkage 250 away from the link base 270 are in the second joint member 81 so that when the second linkage 250 is rotated, the first linkage 240 is simultaneously rotated in the first joint member 80.

In some exemplary embodiments, the thumb mechanism 300 is rotatably connected with a thumb link base 400 of the base 100 so that the thumb mechanism 300 can be rotated to different angles. Furthermore, the thumb mechanism 300 can be rotated to the different positions to define a U-shape space with finger mechanism 200 closed to the mechanism 300.

In some exemplary embodiments, the motor 30 can be replaced by a hydraulic actuating cylinder, a pneumatic cylinder, electromagnetic drive or artificial tendon.

According to this disclosure, fewer motors are provided to the robot hand apparatus 1 of the robot.

According to this disclosure, the defined U-shape space is configured to grab different shaped items.

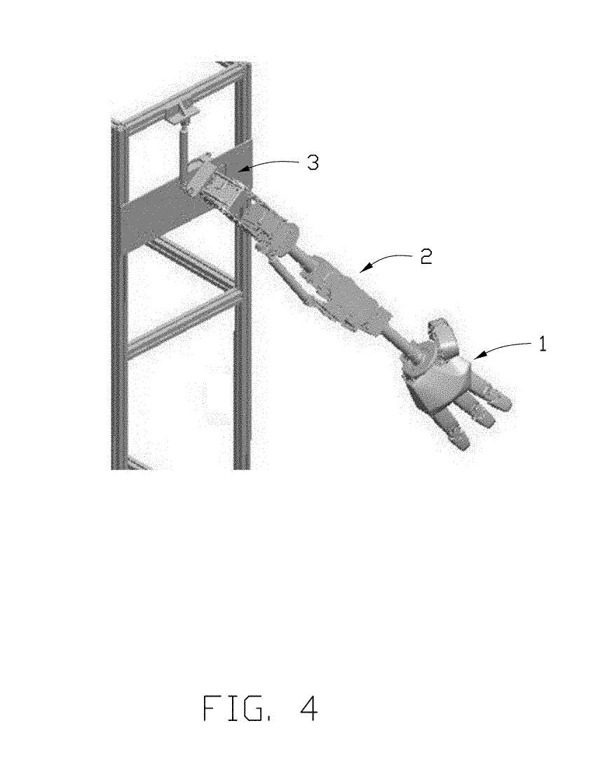

FIG. 4 illustrates a robot arm 2 coupled to the robot hand apparatus 1. A base 3 is coupled to the robot arm 2.

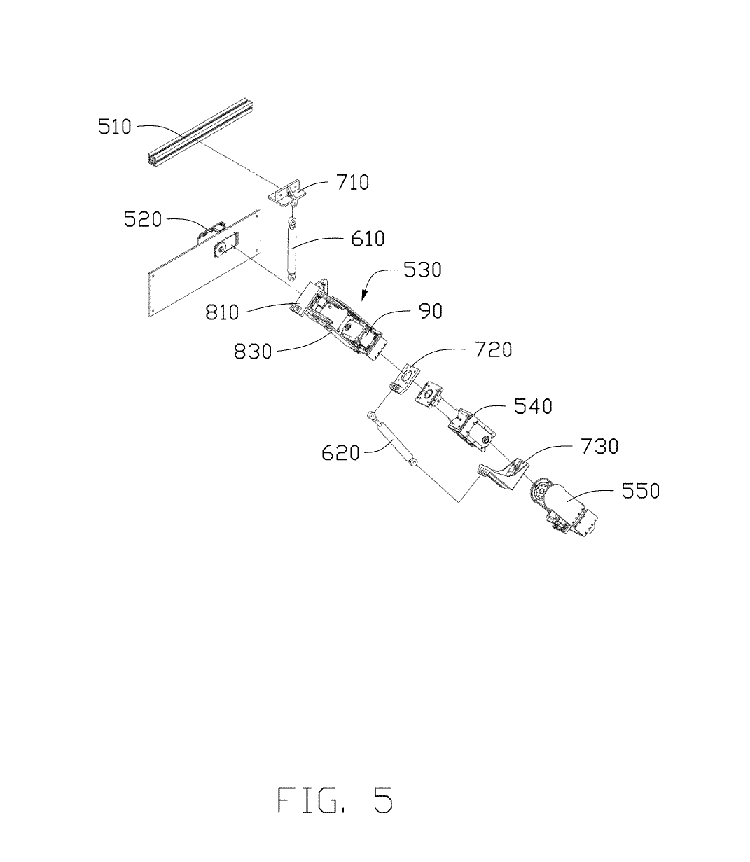

FIG. 5 illustrates the robot arm 2 comprises a first arm base 510, a second arm base 520, an upper arm 530, a middle arm 540, and a lower arm 550.

The second arm base 520 is coupled to the upper arm 530. The first arm base 510 is coupled to a first pneumatic cushion 610 through a first connection member 710. The upper arm 530 is coupled to the middle arm 540 through a second connection member 720. The middle arm 540 is coupled to the lower arm 550 through a third connection member 730. A motor 90 is provided inside the upper arm 530.

A first pneumatic cushion 610 is coupled to the first connection member 710 and a connection portion 810 of the upper arm 530 such that the upper end of the first pneumatic cushion 610 is rotatably coupled to the first arm base 510 through the first connection member 710, and the lower end of the first pneumatic cushion 610 is rotatably coupled to the upper arm 530 through the connection portion 810.

A second pneumatic cushion 620 is coupled to the second connection member 720 and the third connection member 730 so an upper end of the second pneumatic cushion 620 is rotatably coupled to the upper arm 530 through a second connection member 720, and a lower end of the first pneumatic cushion 540 is rotatably connected with the lower arm 550 through the third connection member 730.

The first arm base 510 of the robot arm 2 and the second arm base 520 of the robot arm 2 is coupled to a robot so that a robot can manipulate the robot arm 2.

In this exemplary embodiment, the first pneumatic cushion 530 can provide a support force to the weight of the robot hand apparatus 1 or any item that the robot hand apparatus 1 holds.

In this exemplary embodiment, the second pneumatic cushion 540 can provide a support force to the weight of the robot arm, robot hand apparatus 1 any item that the robot hand apparatus 1 holds.

In some exemplary embodiments, the first pneumatic cushion 530 or the second pneumatic cushion 540 can be replaced by a hydraulic cushion, electromagnetic cushion or artificial tendon.

According to this disclosure, the first pneumatic cushion 530 and the second pneumatic cushion 540 can provide improved support on the robot hand apparatus 1. With more support from the robot arm 2, fewer motors are provided for the robot arm 2 or robot hand apparatus 1. With more support from the robot arm 2, decreased power motors are provided for the robot arm 2 or robot hand apparatus 1.

The exemplary embodiments shown and described above are only examples. Many details are often found in the art such as the other features of a robot hand apparatus and a robot arm for the robot hand apparatus. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A robot hand apparatus comprising:
a base;
a thumb mechanism coupled to the base;
at least three finger mechanisms coupled to the base, wherein each of the finger mechanisms comprising a fingertip member, an intermediate member, a base member, a first linkage, a second linkage, a link arm and a link base;
wherein the fingertip member and the base member are connected through a first linkage, one end of the first linkage is rotatably connected to the fingertip member, and the other end of the first linkage is rotatably connected to base member;
the intermediate member and the link base are connected through a second linkage, one end of the second linkage is rotatably connected to the intermediate member, and the other end of the second linkage is rotatably connected to the base member; and
the base member includes a link arm, one end of the link arm is rotatably connected with the link base, and the link arm is coupled to a motor so that the motor controls the finger mechanism.

2. The robot hand apparatus of claim 1, wherein the fingertip member and the intermediate member are connected by a first joint member and a second fingertip bolt.

3. The robot hand apparatus of claim 1, wherein the intermediate member and the base member are connected by a second joint member through a base member bolt.

4. The robot hand apparatus of claim 1, wherein one end of the first linkage is rotatably connected to the fingertip member by a first joint member through a first fingertip bolt, and the other end of the first linkage is rotatably connected to base member by a second joint member through a second intermediate bolt.

5. The robot hand apparatus of claim 1, wherein one end of the second linkage is rotatably connected to the intermediate member by third joint member through a first intermediate bolt, and the other end of the second linkage is rotatably connected to the base member by third joint member through a second intermediate bolt.

6. The robot hand apparatus of claim 1, wherein one end of the link arm is rotatably connected with the link base by third joint member through a first base bolt, and the link arm is coupled to a motor so that the motor is configured to control the finger mechanism.

7. The robot hand apparatus of claim 1, wherein the thumb mechanism is rotatably connected with a thumb link base of the base.

8. The robot hand apparatus of claim 7, wherein the thumb mechanism is rotated to define a U-shape space with the finger mechanism closed to the thumb mechanism.

9. A robot hand apparatus comprising:
a first arm base;
a second arm base;
an upper arm;
a middle arm;
a lower arm, wherein
the second arm base is coupled to the upper arm, the first arm base is coupled to a first pneumatic cushion through a first connection member, the upper arm is coupled to the middle arm through a second connection member, the middle arm is coupled to the lower arm through a third connection member, and a motor is provided inside the upper arm.

10. The robot hand apparatus of claim 10, wherein
A first pneumatic cushion is coupled to the first connection member and a connection portion of the upper arm, the upper end of the first pneumatic cushion is rotatably coupled to the first arm base through the first connection member, and the lower end of the first pneumatic cushion is rotatably coupled to the upper arm through the connection portion.

11. The robot hand apparatus of claim 10, wherein
A second pneumatic cushion is coupled to the second connection member and the third connection member, the upper end of the second pneumatic cushion is rotatably coupled to the upper arm through a second connection member, and the lower end of the first pneumatic cushion is rotatably connected with the lower arm through the third connection member.

12. The robot hand apparatus of claim 10, wherein
the first pneumatic cushion is a hydraulic cushion, electromagnetic cushion or artificial tendon.

13. The robot hand apparatus of claim 10, wherein
the second pneumatic cushion is replaced by a hydraulic cushion, electromagnetic cushion or artificial tendon.
